(19) United States
(12) Patent Application Publication
(10) Pub. No.: US 2016/0045909 A1
(43) Pub. Date: Feb. 18, 2016

(54) TREATMENT OF ALKALI SILICA GEL AND ALKALI POROUS METAL OXIDE COMPOSITIONS

(71) Applicants: SIGNA CHEMISTRY, INC., New York, NY (US); BOARD OF TRUSTEES OF MICHIGAN STATE UNIVERSITY, East Lansing, MI (US)

(72) Inventors: Michael LEFENFELD, New York, NY (US); James L. DYE, East Lansing, MI (US)

(21) Appl. No.: 14/775,228

(22) PCT Filed: Mar. 14, 2014
(86) PCT No.: PCT/US14/27724

§ 371 Date: Sep. 11, 2015

Related U.S. Application Data
(60) Provisional application No. 61/792,457, filed on Mar. 15, 2013.

(51) Int. Cl. B01J 37/14; B01J 23/04

(52) U.S. Cl. CPC B01J 37/14; B01J 23/04

(57) ABSTRACT

A method for treating Group 1 metal/silica gel compositions that are pyrophoric is provided to convert them into Group 1 metal/silica gel compositions that are no longer pyrophoric. A method for treating Group 1 metal/porous metal oxide compositions that are pyrophoric is provided to convert them into Group 1 metal/porous metal oxide compositions that are no longer pyrophoric. The pyrophoric Group 1 metal/silica gel composition or the pyrophoric Group 1 metal/porous metal oxide composition is treated with a low amount of dry oxygen or low concentration of dry oxygen mixture to convert them into compositions that are no longer pyrophoric or reactive with dry oxygen or air.

### CROSS-REFERENCE TO RELATED APPLICATIONS

This application claims priority to U.S. provisional application 61/792,457, filed Mar. 15, 2013; the disclosure of which is incorporated herein by reference.

### FIELD OF THE INVENTION

This invention relates to methods for treating Group 1 metal/silica gel compositions that are pyrophoric to convert them into Group 1 metal/silica gel compositions that are no longer pyrophoric.

This invention also relates to methods for treating Group 1 metal/porous metal oxide compositions that are pyrophoric to convert them into Group 1 metal/ porous metal oxide compositions that are no longer pyrophoric.

This invention also relates to methods for treating Group 1 metal/silica gel compositions that are non-pyrophoric to convert them into Group 1 metal/silica gel compositions that have improved resistance to ordinary air and humidity, that is, that are stabile in “ambient air” for at least several hours.

This invention also relates to methods for treating Group 1 metal/porous metal oxide compositions that are non-pyrophoric to convert them into Group 1 metal/porous metal oxide compositions that have improved resistance to ordinary air and humidity, that is, that are stabile in “ambient air” for at least several hours.

### BACKGROUND

Alkali metals (i.e., the Group 1 metals of the periodic table), and alloys of alkali metals, are very reactive in their metallic, or neutral, state. The alkali metals and their alloys are very reactive toward air and moisture and may catch fire spontaneously when exposed to these agents (i.e., are pyrophoric). To avoid the inherent hazards associated with their activity, the neutral metal or alloy must often be stored in vacuo or under an inert liquid such as oil in order to protect it from contact with the atmosphere, which may result in oxidation or other reactions. For example, sodium metal is often stored in Nujol oil which must, to avoid unwanted impurities, be removed prior to use in chemical reactions. This places severe restrictions on the shipment and use of sodium metal, Na⁰.

Additionally, liquid alkali metals and liquid alkali metal alloys are also very reactive. For example, it is well-known that liquid alloys of Na and K are very pyrophoric. Exposure to air results in spontaneous and violent ignition.

U.S. Pat. No. 7,211,539, which is herein incorporated by reference in its entirety, describes a Group 1 metal/silica gel composition which has been prepared to handle alkali metals and their alloys in a form that is more stable without a significant loss in metal reactivity. U.S. Pat. No. 7,211,539 discloses four types of Group 1 metal/silica gel compositions known as Stage 0, Stage I, Stage II and Stage III which are formed with different properties depending on the conditions used to prepare them.

Specifically, Stage 0 Group 1 metal/silica gel composition is formed by mixing a liquid Group 1 metal with silica gel (“SG”) in an inert atmosphere under isothermal conditions sufficient to absorb the liquid Group 1 metal into the silica gel pores. The Group 1 metal/silica gel composition produced reacts with dry O₂ and thus may be pyrophoric. By “pyrophoric”, it is meant that the compositions react exothermically enough with ambient air to ignite.

Stage I Group 1 metal/silica gel composition is formed by mixing a liquid Group 1 metal with silica gel under exothermic conditions sufficient to absorb the liquid Group 1 metal into the silica gel pores. The Stage I Group 1 metal/silica gel composition produced generally do not react with dry O₂. However, it has been observed that sometimes the Stage I materials such as Stage I sodium silica gel (i.e., Na-SG) composition contain presence of sodium metal, Na⁰, on its surface that did not get absorbed into the silica gel pores, which reacts with oxygen and air, and thus can be pyrophoric.

Stage II Group 1 metal/silica gel composition is formed by mixing a liquid Group 1 metal with silica gel under conditions sufficient to absorb the liquid Group 1 metal into the silica gel pores and heating the resulting mixture to a temperature of between about 215° C. to about 400° C. The Stage II Group 1 metal/silica gel composition produced does not react with dry O₂ and is stable in air.

Stage III Group 1 metal/silica gel composition is formed by mixing a liquid Group 1 metal with silica gel under conditions sufficient to absorb the liquid Group 1 metal into the silica gel pores and heating the resulting mixture to a temperature of above about 400° C. The Stage III Group 1 metal/silica gel composition produced does not react with dry O₂ and is stable in air.

Alternatively, U.S. Pat. No. 7,259,128, which is herein incorporated by reference in its entirety, describes a Group 1 metal/porous metal oxide composition that has also been prepared to handle alkali metals and their alloys in a form that is more stable without a significant loss in metal reactivity. U.S. Pat. No. 7,259,128 discloses three types of Group 1 metal/porous metal oxide composition known as Stage 0, Stage I, and Stage II which are formed with different properties depending on the conditions used to prepare them.

A Stage 0 Group 1 metal/porous metal oxide composition is formed by mixing a liquid Group 1 metal or alloy with a porous metal oxide selected from porous titanium oxide and porous alumina in an inert atmosphere under isothermal conditions near ambient temperatures sufficient to absorb the liquid Group 1 metal or alloy into the porous metal oxide pores. The Group 1 metal/porous metal oxide composition produced reacts with dry O₂ and thus may be pyrophoric.

Stage I Group 1 metal/porous metal oxide composition is formed by mixing a Group 1 metal or alloy with porous metal oxide selected from porous titanium oxide and porous alumina under exothermic conditions that may be above ambient temperatures sufficient to absorb the Group 1 metal or alloy into the porous metal oxide pores. The Group 1 metal/porous metal oxide composition produced does not react with dry O₂. However, if the metal, such as sodium metal, Na⁰, for example, is not completely absorbed into the silica gel pores, which reacts with oxygen and air, and thus can be pyrophoric.

Stage II Group 1 metal/porous metal oxide composition is formed by mixing a liquid Group 1 metal or alloy with porous metal oxide under conditions sufficient to absorb the liquid Group 1 metal or alloy into the porous metal oxide pores and heating the resulting mixture to a temperature of about 150° C. or higher. The Group 1 metal/porous metal oxide composition produced does not react with dry O₂.

Although the Group 1 metal/silica gel composition of U.S. Pat. No. 7,211,539 and the Group 1 metal/porous metal oxide composition of U.S. Pat. No. 7,259,128 both represent significant improvement over prior methods for handling alkali metals and alkali metal alloys, there still exists respective Stage 0 (and possibly Stage I) compositions which remain reactive with dry O₂ or air, and may be pyrophoric. For example, Stage 0 samples of a NaK alloy (NaₘKₙ) in silica gel (SG) that are made by mixing the liquid alloy with calcined silica gel at room temperature are pyrophoric. NaK alloys, or sodium-potassium alloys, are known in the art have a molar ratio of m to n generally of about 0.5 to about 3.0. Examples of typical NaK alloys include, for example, NaK₂, and Na₂K alloys. Such Stage 0 compositions have a shiny black surface and presumably are coated with the alloy, which ignites in air, causing the sample to get hot and either burn completely or convert to Stage II material, which no longer contains free metallic particles.

In view of the above, there is a need for a method to further treat pyrophoric Group 1 metal/silica gel compositions and pyrophoric Group 1 metal/porous metal oxide compositions so that they will not react with dry O₂ or air, and are no longer pyrophoric. By “no longer pyrophoric” or “not pyrophoric”, it is meant that the compositions do not react exothermically enough with ambient air to ignite.

### SUMMARY

Group 1 metal/silica gel compositions which can be pyrophoric such as Stage 0 Group 1 metal/silica gel compositions and Stage I Group 1 metal/silica gel compositions may be treated by exposing them to low amounts of dry oxygen or dry oxygen mixtures, like dry air, until they are no longer pyrophoric or reactive with dry oxygen or ambient air.

Group 1 metal/porous metal oxide compositions which can be pyrophoric such as Stage 0 Group 1 metal/porous metal oxide compositions and Stage I Group 1 metal/porous metal oxide compositions may be treated by exposing them to low amounts of dry oxygen or dry oxygen mixtures until they are no longer pyrophoric or reactive with dry oxygen or ambient air.

### BRIEF DESCRIPTION OF THE DRAWINGS

FIG. 1 is a Differential Scanning calorimetry (DSC) diagram showing changes in DSC of a Na-SG preparation after treatment in accordance with a method of the invention.

FIG. 2 is a Differential Scanning calorimetry (DSC) diagram showing DSC of a commercially manufactured Na-SG sample after treatment in accordance with a method of the invention.

FIG. 3 is a Differential Scanning calorimetry (DSC) diagram showing DSC of another commercially manufactured Na-SG sample after treatment in accordance with a method of the invention.

FIG. 4 is a Differential Scanning calorimetry (DSC) diagram showing differences in DSC traces for a preparation of Na₂K-SG sample after treatment in accordance with a method of the invention.

FIG. 5 shows the mass change results of two commercially manufactured Na-SG samples exposed to laboratory air for an hour.

FIG. 6 shows the mass change result of a sample of Na₃K-SG exposed to laboratory air over time.

### DETAILED DESCRIPTION

It has been discovered that both pyrophoric and non-pyrophoric Group 1 metal/silica gel compositions and Group 1 metal/porous metal oxide compositions may be treated with low amounts of dry oxygen or dry oxygen mixtures until they are no longer pyrophoric or reactive with dry oxygen or air. That is, the pyrophoric Group 1 metal/silica gel compositions and Group 1 metal/porous metal oxide compositions are treated with dry oxygen or dry oxygen mixtures in a slow and gradual manner until they are no longer pyrophoric or reactive with dry oxygen or air. This process may be referred to as “taming”.

The dry oxygen mixtures can be a mixture of oxygen and another inert gas (e.g., He—O₂, N₂—O₂, Ar—O₂, CO₂—O₂, dry air, etc.). The preferred embodiment are generally N₂—O₂ mixtures using less than 20% O₂ (including less than 10% O₂ or less than 5% O₂), as they can be easily prepared by the partial pressure modification of air with N₂ or other inert gases. The ratio should be optimized to include the highest percentage of O₂ to perform the taming process in the most expedited procedure without allowing the temperature to rise and alter the Group 1 metal/silica gel compositions or Group 1 metal/porous metal oxide compositions. In other words, the compositions may be treated with sufficient O₂ under substantially adiabatic reaction conditions and for a time sufficient such that they are no longer pyrophoric or reactive with dry oxygen or ambient air. The oxygen composition and its introduction may be adjusted so that the taming reaction does not cause a significant temperature change (i.e., less than 5° C.), is essentially isothermal, or that the heat of reaction can be absorbed by a modest increase in the temperature of the products and/or off gasses. One indication of the reaction being complete is the composition which initially is black or shiny black in appearance becomes white or off-white. The composition will gain mass as a result of the reaction. For example, the composition may gain up to about 1 mass % though generally about 0.5 mass % or less or, in some embodiments, about 0.25 mass % or less.

In one embodiment of the invention initial treatments of Stage 0 Group 1 metal/silica gel compositions or Group 1 metal/porous metal oxide compositions, which are more pyrophoric than Stage 1 Group 1 metal/silica gel compositions or Group 1 metal/porous metal oxide compositions, involved allowing oxygen at atmospheric pressure to diffuse into a sample that initially contained helium at atmospheric pressure, followed by reducing the pure helium pressure to about 600 torr and opening the flask to pure dry oxygen at atmospheric pressure. Thus, the mixture was about 20% O₂ and 80% He. Subsequent exposure to pure dry oxygen at atmospheric pressure could be carried out with no further reaction. As alternate embodiments, nitrogen, argon, other inert gases or a mixture of inert gases could be substituted for helium at any stage and in the same or different amounts/partial pressures. Since Stage 1 Group 1 metal/silica gel compositions or Group 1 metal/porous metal oxide compositions are usually not pyrophoric, pure dry oxygen at about 200 torr could be introduced into an evacuated sample. Therefore, the introduction of oxygen to Stage 0 samples should be done gradually, while Stage 1 samples are more tolerant. It should be recognized that the method of the present invention (e.g. the taming) may be carried out continuously using diluted dry air. Such a continuous process may be carried out in any suitable reactor such as, for example, a fluidized bed or a rotary kiln.

The Group 1 metal/silica gel compositions and Group 1 metal/porous metal oxide compositions may be any such compositions prepared by the methods of U.S. Pat. Nos. 7,259,128 and 7,211,539, or any other methods known in the art.

To practice the method of the invention, the Group 1 metal/silica gel or Group 1 metal/porous metal oxide composition is placed in a sealed container under a vacuum or an inert atmosphere (e.g., He or N₂ atmosphere), and pure dry oxygen (or dry oxygen mixture) is introduced into the container. For example, samples of NaₘKₙ-SG which were pyrophoric, or reactive with O₂ (i.e., Stage 0 NaₘKₙ-SG), may be treated by exposing them to low amounts of dry oxygen under an inert atmosphere.

This treatment can take place under atmospheric pressure and room temperature. Other conditions of temperature and pressure may be used as long as the O₂ concentration is adjusted accordingly. It is recognized that oxygen partial pressure (which correlates to concentration) is the operative parameter. Thus if subatmospheric pressures are used, higher oxygen concentrations, for example that are present in ambient air can be used. Pressures above atmospheric pressure may also be used if the O₂ concentration (partial pressure) and/or rate of introduction is adjusted. Heating can be done before exposure to oxygen for Na-SG to create the pre-tamed Stage I composition.

The amount of dry oxygen or dry oxygen mixture consumed will be less than that equivalent to 10% molar based on the Group 1 metal content of the metal-SG or metal-metal oxide, but of course, the actual amount of oxygen used may far exceed that because of system losses. The dry oxygen or dry oxygen mixture may be introduced at a rate of 1 to 10%/hour of the molar metal content. Treatment time will depend on the rate and concentration at which oxygen is introduced, but will preferably be less than 8 hours, more preferably less than 4 hours and still more preferably less than one hour. Some samples can be left overnight with dry oxygen present. The dry oxygen or dry oxygen mixture is introduced into the container at pressure ranging from 50 Torr to 760 Torr. Superatmospheric pressures can be used if the oxygen concentration is adjusted accordingly, but are not necessary.

While the oxygen or oxygen mixture is being introduced into the container (or reactor), the previous inert gas atmosphere in the container may be pumped out at the same or different rate so that the present atmosphere within the container is gradually being replaced by more of the new oxygen or oxygen mixture. Typically, the oxygen level was increased in two or three steps and the container was evacuated after the taming process and introduced into a helium-filled glove box, where it was opened. Later tests showed the samples to be non-pyrophoric and to display the DSC patterns shown in the examples. Tamed samples could be opened in air for use after the oxygen treatments described, without putting them in the glove box, with no measurable loss of reduction ability from room humidity or air for a period of several hours, generally at least up to 3 hours or even up to 5 hours.

After the pyrophoric Group 1 metal/silica gel or Group 1 metal/porous metal oxide composition has been treated in this manner, it has been discovered that these compositions are no longer pyrophoric and are unreactive with dry O₂ or air. More importantly, it has been discovered that the otherwise commercially important reactive nature of these compositions (e.g., as powerful reducing agents for chemical reactions such as Birch reductions or Wurtz reductions, etc.) have not been significantly reduced (e.g., 3-5% is typical) as a result of this treatment. For example, these treated Group 1 metal/silica gel or Group 1 metal/porous metal oxide compositions have been discovered to retain over 90% of their original reducing capacity.

It is unclear what causes this protection against oxidation by air. It is theorized that a gradual and controlled introduction of oxygen to pyrophoric Group 1 metal/silica gel or Group 1 metal/porous metal oxide composition in the manner discovered may lead to the formation of a protective oxidized layer on the outside of the composition particles or the formation of oxide groups (i.e., SiO— or SiO₂-groups) that block the pores and inhibit migration of molecular oxygen to the interior of the particle where the reactive alkali metal resides.

This method of the invention can also be applied to Stage I materials. For example, because the formation of Na-SG requires heating to 150° C. or higher, Stage 0 Na-SG cannot be made, only Stage I Na-SG. However, samples of Stage I Na-SG made by heating Na and SG in a steel reactor (with rotation) sometimes can be pyrophoric if sodium metal, Na⁰, remains present in the sample. On the other hand, some commerically available Stage I Na-SG sample that were made in a fluidized bed are generally not observed to be pyrophoric.

When pyrophoric Na-SG compositions were treated with with He—O₂ or N₂—O₂ mixtures in accordance with the invention, it was discovered that the treated sample was no longer pyrophoric and could be routinely handled in laboratory air with no loss of reduction potential.

### EXAMPLES

The following represent exemplary embodiments that are within the scope of the invention. A skilled artisan will readily recognize that the invention includes many more embodiments and that these are just examples, and are not limiting. The invention includes all such various embodiments, alterations, improvements, and modifications.

### Example 1

Stage 0 Na₂K-SG composition was placed into a flask under an atmosphere of helium. Pure dry oxygen was slowly diffused into the flask which caused the surface to change from shiny black to dull black. However, after pumping out the helium and continuing to admit pure dry oxygen at 200 torr, the surface of the Na₂K-SG composition was observed to turned white, and the sample did not heat up or catch fire. The treated Na₂K-SG composition was non-pyrophoric in lab air and was completely non-reactive with dry air. Analysis by H₂ evolution with ethanol and water indicated only minor changes in the reducing capacity.

### Example 2

Stage 0 K₂Na-SG composition was placed into a flask under an atmosphere of helium. Pure dry oxygen was first allowed to slowly diffuse into the flask and the helium diffused out. After about one hour, helium was pumped out and pure dry oxygen was pumped into the flask at 200 torr. The K₂Na-SG composition did not heat up or catch fire. The treated K₂Na-SG composition was non-pyrophoric in lab air and was completely non-reactive with dry air. Analysis by H₂ evolution with ethanol and water indicated only minor changes in the reducing capacity.

### Example 3

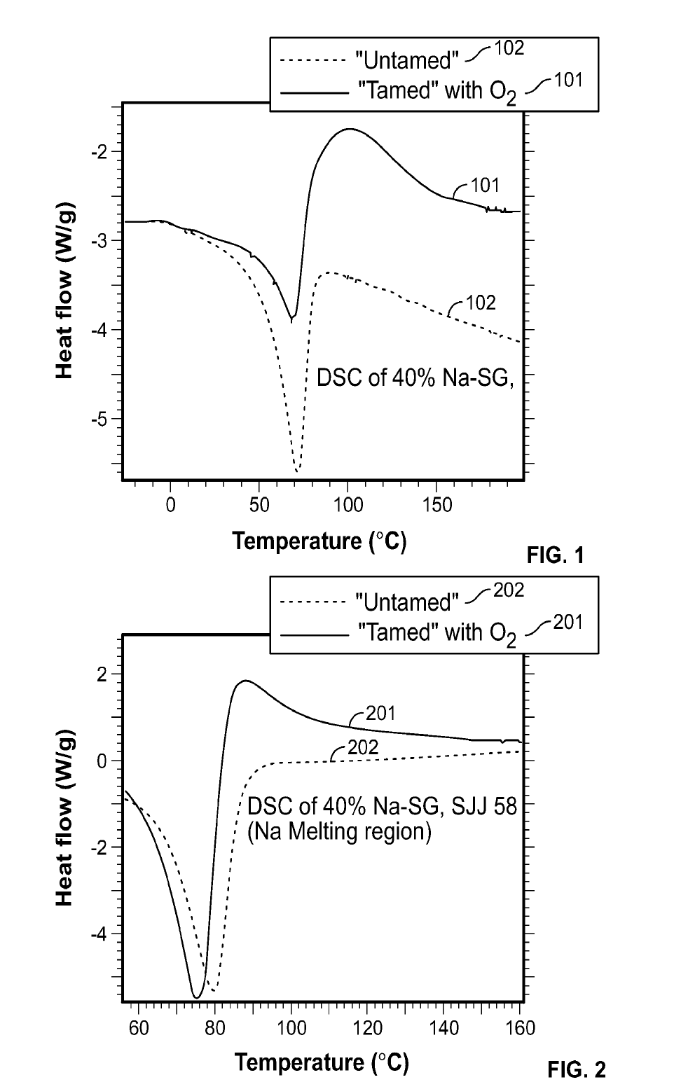

Two samples of Stage I Na-SG, 40% metal loading, were prepared by heating Na and SG in a steel reactor (with rotation). One sample 101 was treated with oxygen (i.e., “tamed” with O₂) in accordance with the present invention at room temperature with admission of low pressures of pure oxygen (200 torr) after evacuation of the helium. The other sample 102 (i.e., “untamed”) was not treated with oxygen in accordance with the invention. A Differential Scanning calorimetry (DSC) was performed to compare the behavior of the two Na-SG samples in air over the same temperature range and the results are shown in FIG. 1. As FIG. 1 shows, in the DSC traces the presence of exotherms immediately following the melting endotherm for sodium peaking at approximately 95° C. So the DSC shows that some exothermic reaction followed the melting of the sodium in the pores for the tamed material, while the untamed material returned to its baseline trajectory

### Example 4

Two samples of Stage I Na-SG, 40% metal loading, made in a fluidized bed was purchased from Johnson-Matthey. One sample 201 was treated with oxygen (i.e., “tamed” with O₂) in accordance with the present invention at room temperature with admission of low pressures of pure oxygen (200 torr) after evacuation of the helium. The other sample 202 (i.e., “untamed”) was not treated with oxygen in accordance with the present invention. A Differential Scanning calorimetry (DSC) was performed to compare the behavior of the two Na-SG samples in air over the same temperature range and the results are shown in FIG. 2. The untamed sample did not show the post-melting exotherm, confirming the general observation that a protective species was formed by the oxygen treatment that can react exothermically with the molten metal.

### Example 5

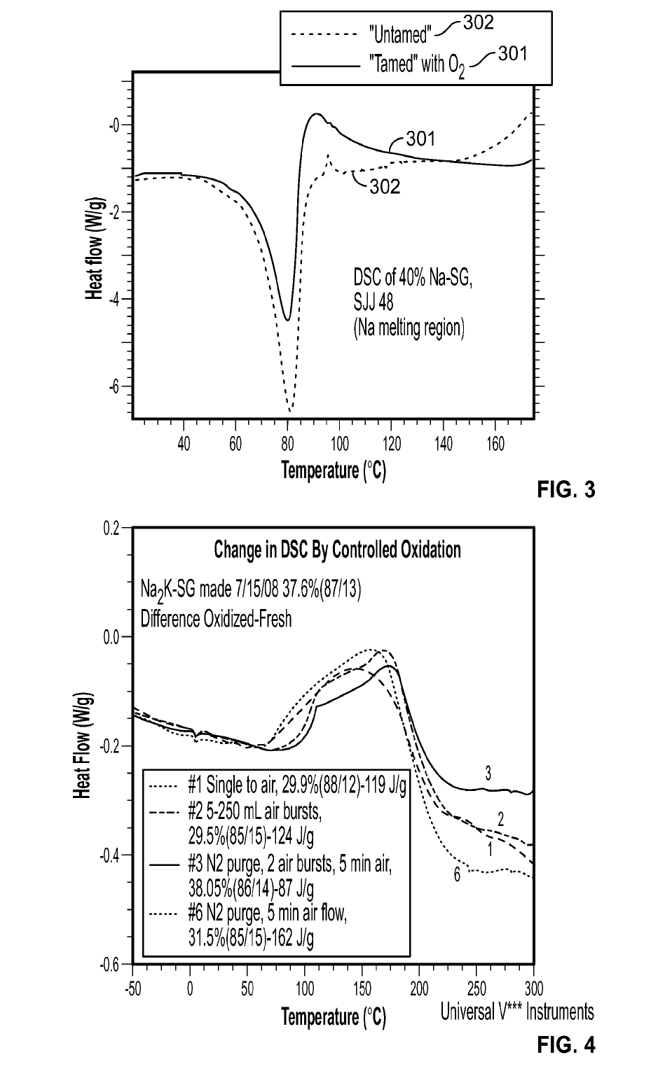

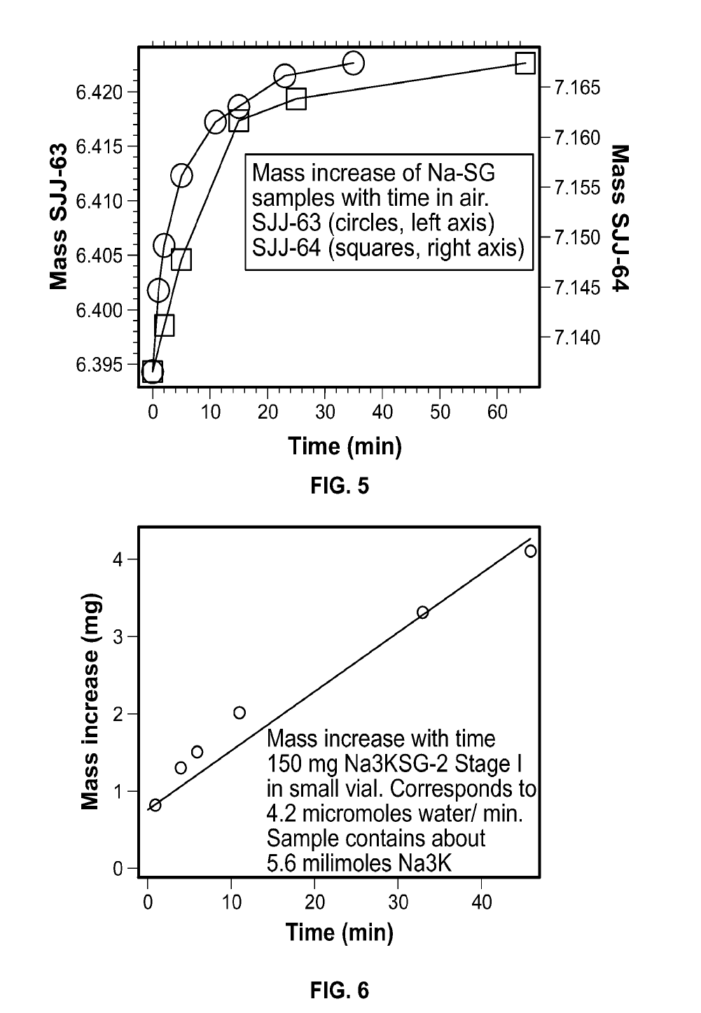

Two samples of Stage I Na-SG, 40% metal loading, made in a fluidized bed were manufactured at commercial scale. One sample 301 was treated with oxygen (i.e., “tamed” with O₂) in accordance with the present invention at room temperature with admission of low pressures of pure oxygen (200 torr) after evacuation of the helium. The other sample 302 (i.e., “untamed”) was not treated with oxygen in accordance with the present invention. A Differential Scanning calorimetry (DSC) was performed to compare the behavior of the two Na-SG samples in air over the same temperature range and the results are shown in FIG. 3. It was further observed that there was a small peak at 95° C. in the untamed sample 302, which the small peak is an artifact of the trace used as a background to avoid baseline drift.

Thus, the DSC traces of O₂-treated samples in FIGS. 1-3 all show the presence of an exotherm after the melting endotherm of Na⁰. The species formed have not been identified, but are likely to consist of partially reduced oxygen molecules such as peroxide, bound to the silica.

### Example 6

J. L. Dye et al, “Nano-Structures and Interactions of Alkali Metals within Silica Gel”, Chemistry of Materials, 23, 2388-2397 (2011), which is herein incorporated by reference in its entirety, reported that heating Stage 0 NaₘKₙ-SG to form Stage I results in ionization of K and incorporation of (presumably) mobile K⁺ and e⁻ in the silica framework. The mobile electron may be loosely attached to the SiO₂ groups. These Stage I samples have Na⁰ in the pores and K⁺ in the silica framework. Thus, as with Na-SG, such Stage I samples can be “tamed” or are naturally non-pyrophoric. Even so, various samples of these Stage I Na₂K-SG were nevertheless treated with oxygen or dry air and compared by Differential Scanning calorimetry. The results of the DSC traces are shown in FIG. 4 as difference spectra.

Specifically, in FIG. 4, DSC traces were compared for 4 Stage I Na₂K-SG samples. These four samples were separately prepared Stage 0 samples Treatments: Various amounts of dry air were used in brief bursts and then pumped out. The first sample (#1) had a single burst of air. The second sample (#2) was treated with 5 successive air bursts. The third sample (#3) had an N₂ purge, 2 air bursts, and then left 5 min in air at atmospheric pressure. The fourth sample (#4) had an N₂ purge followed by 5 min of air flow. These results demonstrate that various combinations of air treatment and duration can all be effective in achieving the same taming as shown by the exotherm around 95° C.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention.

The claimed invention is:

1. A method for treating a pyrophoric or non-pyrophoric Group 1 metal/silica gel composition or Group 1 metal/porous metal oxide composition comprising the step of:
exposing said Group 1 metal/silica gel composition or Group 1 metal/porous metal oxide composition to dry oxygen or dry oxygen mixtures under conditions until the Group 1 metal/silica gel composition or the Group 1 metal/porous metal oxide composition is no longer pyrophoric or no longer reactive with dry oxygen.

2. The method of claim 1, wherein said dry oxygen or dry oxygen mixture is introduced at a partial pressure ranging from 50 Torr to 760 Torr, or ranging from 100 to 500 Torr, or ranging from 100 to 300 Torr.

3. The method of claim 1, wherein said dry oxygen mixture is a mixture of He—O₂, N₂—O₂, Ar—O₂, CO₂—O₂ or dry air.

4. The method of claim 1, wherein said dry oxygen mixture contains less than 20% O₂ or less than 10% O₂.

5. The method of claim 1, wherein said Group 1 metal/silica gel composition or Group 1 metal/porous metal oxide composition is exposed to said dry oxygen or said dry oxygen mixture less than 8 hours, or less than 4 hours, or less than 1 hour.

6. The method of claim 1, wherein said exposing step occurs under atmospheric pressure, or between 700-800 Torr.

7. The method of claim 1, wherein said exposing step occurs at room temperature, or between 20-30° C.

8. The method of claim 1, wherein dry oxygen is introduced at a rate of 1 to 10%/hour of the molar metal content of said Group 1 metal/silica gel composition or Group 1 metal/porous metal oxide composition.

9. The method of claim 1, wherein said Group 1 metal/silica gel composition is Na-SG or NaₘKₙ-SG, wherein the molar ratio of m to n is about 0.5 to about 3.0.

10. The method of claim 1, wherein the treated Group 1 metal/silica gel composition or the treated Group 1 metal/porous metal oxide composition retains over 90% of said composition's original reducing capacity or over 90% of said composition's reducing capacity.

11. The method of claim 1, wherein the treated Group 1 metal/silica gel composition or the treated Group 1 metal/porous metal oxide composition retains over 90% of said composition's original reducing capacity for Birch reductions or Wurtz reductions.

12. A Group 1 metal/silica gel composition or Group 1 metal/porous metal oxide composition treated according to method of claim 1.

13. A Group 1 metal/silica gel composition or Group 1 metal/porous metal oxide composition having an oxidized outer layer.

14. A Group 1 metal/silica gel composition or Group 1 metal/porous metal oxide composition of claim 13, wherein the Group 1 metal is Na or NaₘKₙ wherein the molar ratio of m to n is about 0.5 to about 3.0.
